(19) United States
(12) Patent Application Publication
(10) Pub. No.: US 2023/0339397 A1
(43) Pub. Date: Oct. 26, 2023

(54) RETINAL-CONTROLLED MIRROR DEVICE

(71) Applicant: Edward Fleming, Tulsa, OK (US)

(72) Inventor: Edward Fleming, Tulsa, OK (US)

(21) Appl. No.: 18/306,356

(22) Filed: Apr. 25, 2023

Related U.S. Application Data
(60) Provisional application No. 63/334,226, filed on Apr. 25, 2022.

(51) Int. Cl. G06F 3/01; B60R 1/12; G06V 40/19; B60R 1/02

(52) U.S. Cl. CPC B60R 1/025; B60R 1/12; G06F 3/013; G06V 40/19; B60R 2001/1253; B60R 2001/1284

(57) ABSTRACT

The present invention relates to a novel retinal-controlled mirror device. The device is a multipurpose, retinal-controlled mirror system for vehicles. The vehicle mirrors are fitted with a universal retinal scanner that identifies the retinas of the user and tracks their movement to automatically adjust the vehicle mirrors to optimal positions. The vehicle mirrors, when equipped with the universal retinal scanner, ensure that the operator of the motor vehicle always has a clear line of sight through the rear-view and side-view mirrors, which are controlled by the eyes of the operator. Thus, the device prevents distractions and allows multiple users of the same vehicle to automatically adjust mirrors to a desired position.

### CROSS-REFERENCE TO RELATED APPLICATION

The present application claims priority to, and the benefit of, U.S. Provisional Application No. 63/334,226, which was filed on Apr. 25, 2022, and is incorporated herein by reference in its entirety.

### FIELD OF THE INVENTION

The present invention relates generally to the field of retinal-controlled mirror devices. More specifically, the present invention relates to a retinal-controlled mirror system for use in a vehicle which ensures the driver always has a clear line of sight through the mirrors. Accordingly, the present disclosure makes specific reference thereto. Nonetheless, it is to be appreciated that aspects of the present invention are also equally applicable to other like applications, devices, and methods of manufacture.

### BACKGROUND

By way of background, this invention relates to improvements in retinal-controlled mirror devices. Generally, multiple drivers using the same vehicle may have to constantly adjust the rear-view and side-view mirrors. Further, making these manual adjustments can be frustrating and time consuming. Additionally, people may get distracted if they have to adjust the mirror at a crucial time to avoid collisions and/or wrecks.

Furthermore, blind zones, or blind spots, in a vehicle are a leading cause of accidents between vehicles. A driver checking rear-view or side-view mirrors that are not in correct alignment before changing lanes assumes, often incorrectly, that because there is no vehicle visible in the mirror, that a lane change can safely be performed. However, a blind zone due to incorrect alignment of vehicle mirrors may cause nearby vehicles to be out of the field of view of the driver.

Correct alignment of the rear-view or side-view mirrors based on seat position, height, and distance of the driver from the mirrors can reduce accidents related to blind zones by a significant factor. Nevertheless, studies show that a majority of drivers do not know how to align mirrors correctly. Furthermore, when drivers use vehicles that are not their own, or use a shared vehicle, drivers often find the process of manual adjustment of vehicle mirrors to be too bothersome for a single trip.

Accordingly, a need remains for a retinal-controlled vehicle mirror that ensures the operator of a motor vehicle always has a clear line of sight. Further, a retinal-controlled vehicle mirror allows drivers to control the mirrors through their eyes via a universal retinal scanner.

Therefore, there exists a long-felt need in the art for a retinal-controlled mirror device that provides users with a retinal-controlled mirror system for use in a vehicle, ensuring the driver always has a clear line of sight through the mirrors. There is also a long-felt need in the art for a retinal-controlled mirror device that allows drivers to control the mirror through their eyes via a universal retinal scanner. Further, there is a long-felt need in the art for a retinal-controlled mirror device that identifies the position of the driver’s retinas and tracks their movement to automatically adjust the mirrors to optimal positions. Moreover, there is a long-felt need in the art for a device that prevents a user from having to manually adjust the rear-view and side-view mirrors in their vehicle. Further, there is a long-felt need in the art for a retinal-controlled mirror device that prevents distractions and allows multiple users of the same vehicle to automatically adjust mirrors to a desired position. Finally, there is a long-felt need in the art for a retinal-controlled mirror device that prevents incorrectly adjusted mirrors, as the mirrors are adjusted based on a user’s retinas.

The subject matter disclosed and claimed herein, in one embodiment thereof, comprises a retinal-controlled mirror device. The device is a multipurpose, retinal-controlled mirror system for vehicles. The vehicle mirrors are fitted with a universal retinal scanner that identifies the retinas of the user and tracks their movement to automatically adjust the vehicle mirrors to optimal positions. The vehicle mirrors, equipped with the universal retinal scanner, ensures that the operator of the motor vehicle always has a clear line of sight through the rear-view and side-view mirrors, which are controlled by the eyes of the operator. Thus, the device prevents distractions and allows multiple users of the same vehicle to automatically adjust mirrors to a desired position.

In this manner, the retinal-controlled mirror device of the present invention accomplishes all of the foregoing objectives and provides users with a device that allows drivers to control their vehicle mirrors through their eyes. The device is a vehicle mirror with a universal retinal scanner. The device allows the automatic adjustment of a vehicle mirror.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retinal-controlled mirror device. The device is a multipurpose, retinal-controlled mirror system for vehicles. The vehicle mirrors are fitted with a universal retinal scanner that identifies the retinas of the user and tracks their movement to automatically adjust the vehicle mirrors to optimal positions. The vehicle mirrors, equipped with the universal retinal scanner, ensures that the operator of the motor vehicle always has a clear line of sight through the rear-view and side-view mirrors, which are controlled by the eyes of the operator. Thus, the device prevents distractions and allows multiple users of the same vehicle to automatically adjust mirrors to a desired position.

In one embodiment, the vehicle mirrors may include mirrors on airplanes, buses, boats and various other vehicles as is known in the art.

In one embodiment, the retinal-controlled mirror device comprises a universal retinal scanner secured within at least one vehicle mirror. The universal retinal scanner is capable of detecting a user’s retinas while in a vehicle. Generally, the universal retinal scanner is electrically connected to a motor to move the vehicle mirrors.

In one embodiment, the universal retinal scanner includes an encasement substantially rectangular shaped with arcuate edges. A scanning lens is secured within the encasement for reading the retinal pattern of the user. A central processing unit is positioned within the encasement. The central processing unit is electrically connected to the scanning lens. An EEPROM chip is electrically connected to the central processing unit for storing the retinal patterns of drivers. A shading member is secured around a peripheral edge of the encasement surrounding the scanning lens to prevent contamination during scanning of the user’s retinas.

In one embodiment, the scanning lens, after identifying a user’s retinas, sends a signal to the central processing unit. The central processing unit is configured to receive the signal and generate a signal to the motor to control the movement of the vehicle’s mirrors, based on a user’s retina position. Thus, the position/orientation of the side-view and/or rear-view mirrors is adjusted automatically based on a field of view of the driver, determined by the central processing unit based off of the signals sent from the universal retinal scanner. The inputs, outputs, and/or arrangement of the components of the retinal-controlled mirror device may be varied according to design criteria or other particular implementations, as is known in the art.

In use, a user who is operating a vehicle, positions the scanning lens near his or her eye. The scanning lens reads the retinas of the user’s eyes upon the user manually pressing a read button on the universal retinal scanner. In another embodiment, the scanning lens automatically reads the retinas of the user’s eyes whenever they look in a vehicle’s mirrors. Thus, the universal retinal scanner identifies a user’s retinas and tracks their movement to automatically adjust the vehicle mirrors to optimal positions.

Furthermore, the universal retinal scanner is configured to determine a location of the eyes of the driver. For example, the universal retinal scanner scans a user’s retinas and sends the information/data to the central processing unit. The central processing unit analyzes the data and determines a location of the user’s retinas and then engages the motor to move the mirrors to a specific position/orientation, such that blind spots and/or blind zones are eliminated, reduced, and/or minimized. Thus, the retinal-controlled mirror device reduces blind spots/zones to improve safety when changing lanes and driving. Further, the positioning of the mirrors may also be adjusted based on characteristics of the driver (i.e., height, size, etc.).

In one embodiment, the universal retinal scanner is shown built into or embedded into a vehicle’s mirrors. Specifically, the universal retinal scanner is built into the top of a rear-view mirror. In another embodiment, the universal retinal scanner is built into the bottom of a rear-view mirror. In another embodiment, the universal retinal scanner is also built into a top or bottom of a side-view mirror. Typically, any suitable vehicle mirror can have the universal retinal scanner built in. Further, the universal retinal scanner would have a direct wired connection with other universal retinal scanners positioned in the vehicle mirrors, such that all the vehicle mirrors are automatically controlled based on the movement of a user’s retinas.

In one embodiment, the universal retinal scanner is embedded or built into a vehicle mirror. The mirror may be a side-view mirror on the driver’s side of the vehicle. The mirror may be a rear-view mirror of the vehicle. The mirror may be a side-view mirror on the passenger’s side of the vehicle. The number and/or types of the mirrors may be varied according to the design criteria and/or particular implementations.

In one embodiment, the universal retinal scanner in contact with the central processing unit may perform the automatic adjustment of the vehicle mirrors continuously, periodically, and/or at fixed intervals (i.e., based on a pre-determined amount of time). For example, every time a user looks in the vehicle mirrors, the universal retinal scanner would track their retinas and adjust the mirrors accordingly.

In one embodiment, the position of the side-view and/or rear-view mirrors can be adjustable using manual controls, as well as the universal retinal scanner, in the vehicle. Thus, the retinal-controlled mirror device can adjust the position/orientation of the side-view and/or rear-view mirrors and the driver may make further adjustments and/or fine-tune the positioning of the mirrors manually.

In some embodiments, the retinal-controlled mirror device may be installed in the vehicle at a time of manufacturing. For example, the retinal-controlled mirror device may be installed on a particular type (i.e., model, make, year, etc.) of a newly manufactured vehicle.

In some embodiments, the retinal-controlled mirror device may be installed in the vehicle as a separate component (i.e., an after-market part). In one example, the retinal-controlled mirror device may be designed and/or sold for a particular make/model of an existing vehicle.

In yet another embodiment, the retinal-controlled mirror device comprises a plurality of indicia.

Furthermore, the functions performed by the retinal-controlled mirror device may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU) and/or similar computational machines. Additionally, appropriate software, firmware, coding, routines, instructions, opcodes, microcode, and/or program modules may readily be prepared for use with the device, as needed.

The device may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips, and/or multi-chip modules or by interconnecting an appropriate network of conventional component circuits, modifications of which will be readily apparent to those skilled in the art.

In yet another embodiment, a method of automatically adjusting a vehicle’s mirrors via a retinal scanner is disclosed. The method includes the steps of providing a retinal-controlled mirror device comprising a universal retinal scanner embedded within the vehicle’s mirrors. The method also comprises securing the universal retinal scanner within a vehicle’s rear-view and side-view mirrors. Further, the method comprises positioning a receiver in the rear of a vehicle to communicate with the universal retinal scanner. The method also comprises tracking the movement of a user’s retinas via the universal retinal scanner. Finally, the method comprises automatically adjusting the vehicle mirrors based on the movement of a user’s retinas.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one embodiment of the retinal-controlled mirror device of the present invention showing the universal retina scanner embedded in the vehicle mirror in accordance with the disclosed architecture;

FIG. 2 illustrates a front perspective view of one embodiment of the retinal-controlled mirror device of the present invention showing a user utilizing the device in accordance with the disclosed architecture;

FIG. 3 illustrates a side perspective view of one embodiment of the retinal-controlled mirror device of the present invention showing the device within a vehicle in accordance with the disclosed architecture; and

FIG. 4 illustrates a flowchart showing the method of automatically adjusting a vehicle’s mirrors via a retinal scanner in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a retinal-controlled mirror device that provides users with a retinal-controlled mirror system for use in a vehicle, ensuring the driver always has a clear line of sight through the mirrors. There is also a long-felt need in the art for a retinal-controlled mirror device that allows drivers to control the mirror through their eyes via a universal retinal scanner. Further, there is a long-felt need in the art for a retinal-controlled mirror device that identifies the position of the driver’s retinas and tracks their movement to automatically adjust the mirrors to optimal positions. Moreover, there is a long-felt need in the art for a device that prevents a user from having to manually adjust the rear-view and side-view mirrors in their vehicle. Further, there is a long-felt need in the art for a retinal-controlled mirror device that prevents distractions and allows multiple users of the same vehicle to automatically adjust mirrors to a desired position. Finally, there is a long-felt need in the art for a retinal-controlled mirror device that prevents incorrectly adjusted mirrors, as the mirrors are adjusted based on a user’s retinas.

The present invention, in one exemplary embodiment, is a novel retinal-controlled mirror device. The device is a multipurpose, retinal-controlled mirror system for vehicles. The vehicle mirrors are fitted with a universal retinal scanner that identifies the retinas of the user and tracks their movement to automatically adjust the vehicle mirrors to optimal positions. The vehicle mirrors, equipped with the universal retinal scanner, ensures that the operator of the motor vehicle always has a clear line of sight through the rear-view and side-view mirrors, which are controlled by the eyes of the operator. Thus, the device prevents distractions and allows multiple users of the same vehicle to automatically adjust mirrors to a desired position. The present invention also includes a novel method of automatically adjusting a vehicle’s mirrors via a retinal scanner. The method includes the steps of providing a retinal-controlled mirror device comprising a universal retinal scanner embedded within the vehicle’s mirrors. The method also comprises securing the universal retinal scanner within a vehicle’s rear-view and side-view mirrors. Further, the method comprises positioning a receiver in the rear of a vehicle to communicate with the universal retinal scanner. The method also comprises tracking the movement of a user’s retinas via the universal retinal scanner. Finally, the method comprises automatically adjusting the vehicle mirrors based on the movement of a user’s retinas.

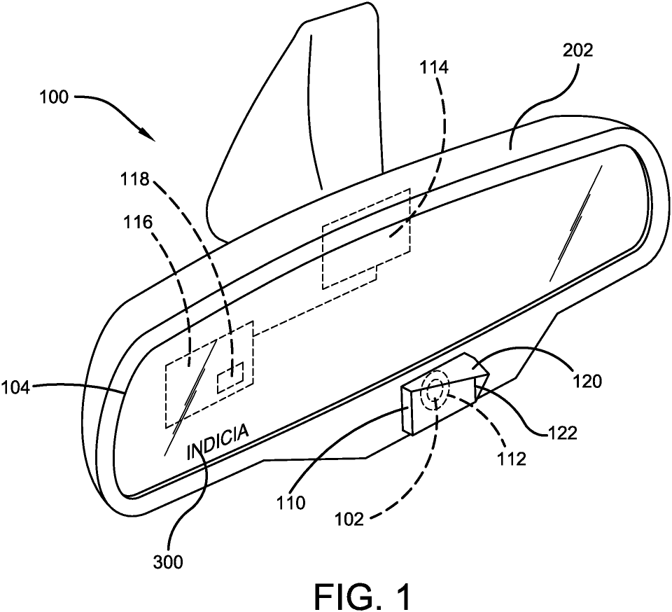

Referring initially to the drawings, FIG. 1 illustrates a perspective view of one embodiment of the retinal-controlled mirror device 100 of the present invention. In the present embodiment, the retinal-controlled mirror device 100 is an improved retinal-controlled mirror device 100 that ensures a driver 106 always has a clear line of sight through the vehicle mirrors 104. Specifically, the retinal-controlled mirror device 100 comprises a universal retinal scanner 102 that is embedded within a vehicle mirror 104. The universal retinal scanner 102 identifies the retinas of the user 106 and tracks their movement to automatically adjust the vehicle mirrors 104 to optimal positions. Thus, the device 100 prevents distractions and allows multiple users 106 of the same vehicle 108 to automatically adjust vehicle mirrors 104 to a desired position.

Further, the retinal-controlled mirror device 100 comprises a universal retinal scanner 102 secured within at least one vehicle mirror 104. The universal retinal scanner 102 is capable of detecting a user’s retinas while in a vehicle 108. Generally, the universal retinal scanner 102 communicates with a receiver 115 positioned in a rear of the vehicle 108 and is electrically connected to a motor 114 to move the vehicle mirrors 104.

Generally, the universal retinal scanner 102 includes an encasement 110 substantially rectangular shaped with arcuate edges. A scanning lens 112 is secured within the encasement 110 for reading the retinal pattern of the user 106. A central processing unit 116 is positioned within the encasement 110. The central processing unit 116 is electrically connected to the scanning lens 112. An EEPROM chip 118 is electrically connected to the central processing unit 116 for storing the retinal patterns of drivers 106. A shading member 120 is secured around a peripheral edge 122 of the encasement 110 surrounding the scanning lens 112 to prevent contamination during scanning of the user’s retinas.

Accordingly, the scanning lens 112, after identifying a user’s retinas, sends a signal to the central processing unit 116. The central processing unit 116 is configured to receive the signal and generate a signal to the motor 114 to control the movement of the vehicle’s mirrors 104 based on a user’s retina position. Thus, the position/orientation of the side-view and/or rear-view mirrors 104 is adjusted automatically based on a field of view of the driver 106 which is determined by the central processing unit 116 based off of the signals sent from the universal retinal scanner 102. Further, the inputs, outputs, and/or arrangement of the components of the retinal-controlled mirror device 100 may be varied according to design criteria or other particular implementations, as is known in the art.

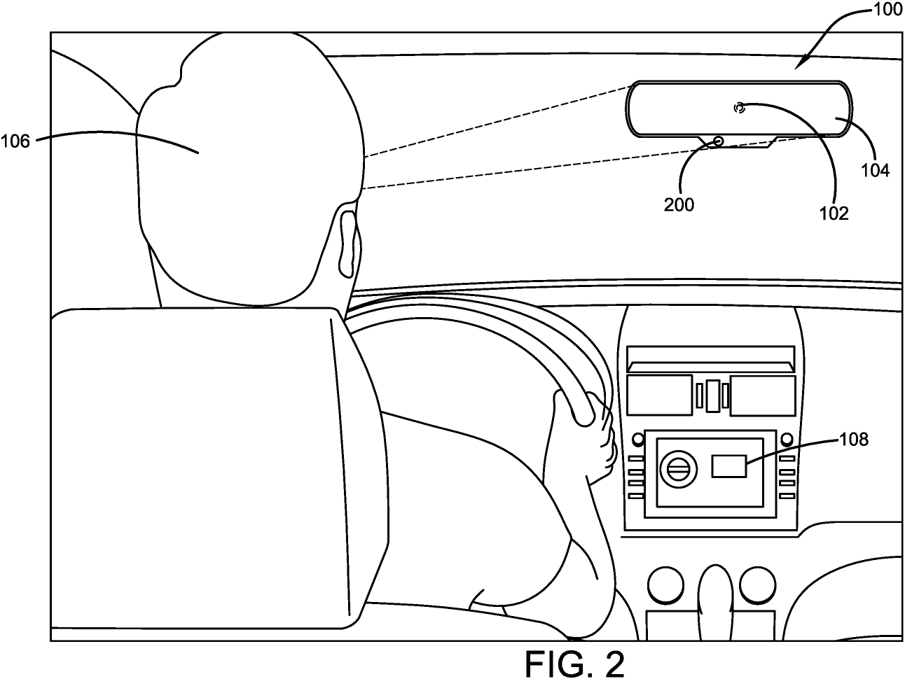

As shown in FIG. 2, in use, a user 106 who is operating a vehicle 108 positions the scanning lens 112 near his or her eye. The scanning lens 112 reads the retinas of the user’s eyes upon the user 106 manually pressing a read button 200 on the universal retinal scanner 102. In another embodiment, the scanning lens 112 automatically reads the retinas of the user’s eyes whenever they look in a vehicle’s mirrors 104. Thus, the universal retinal scanner 102 identifies a user’s retinas and tracks their movement to automatically adjust the vehicle mirrors 104 to optimal positions.

Furthermore, the universal retinal scanner 102 is configured to determine a location of the eyes of the driver 106. For example, the universal retinal scanner 102 scans a user’s retinas and sends the information/data to the central processing unit 116. The central processing unit 116 analyzes the data and determines a location of the user’s retinas and then engages the motor 114 to move the mirrors 104 to a specific position/orientation, such that blind spots and/or blind zones are eliminated, reduced, and/or minimized. Thus, the retinal-controlled mirror device 100 reduces blind spots/zones to improve safety when changing lanes and driving. Further, the positioning of the mirrors 104 may also be adjusted based on characteristics of the driver 106, (i.e., height, size, etc.).

In one embodiment, the universal retinal scanner 102 is shown built or embedded into a vehicle’s mirrors 104. Specifically, the universal retinal scanner 102 is built into the top 202 of a rear-view mirror 104. In another embodiment, the universal retinal scanner 102 is built into the bottom 204 of a rear-view mirror 104. In another embodiment, the universal retinal scanner 102 is also built into a top 202 or bottom 204 of a side-view mirror 104. Typically, any suitable vehicle mirror 104 can have the universal retinal scanner 102 built in. Further, the universal retinal scanner 102 would have a direct wired connection with other universal retinal scanners 102 positioned in the vehicle mirrors 104, such that all the vehicle mirrors 104 are automatically controlled based on the movement of a user’s retinas.

Accordingly, the universal retinal scanner 102 is embedded or built into a vehicle mirror 104. The mirror 104 may be a side-view mirror on the driver’s side of the vehicle 108. The mirror 104 may be a rear-view mirror of the vehicle 108. The mirror 104 may be a side-view mirror on the passenger’s side of the vehicle 108. The number and/or types of the mirrors 104 may be varied according to the design criteria and/or particular implementations.

Furthermore, the universal retinal scanner 102 in contact with the central processing unit 116 may perform the automatic adjustment of the vehicle mirrors 104 continuously, periodically, and/or at fixed intervals (i.e., based on a pre-determined amount of time). For example, every time a user 106 looks in the vehicle mirrors 104, the universal retinal scanner 102 would track their retinas and adjust the mirrors 104 accordingly.

In one embodiment, the position of the side-view and/or rear-view mirrors 104 can be adjustable using manual controls, as well as the universal retinal scanner 102, in the vehicle 108. Thus, the retinal-controlled mirror device 100 can adjust the position/orientation of the side-view and/or rear-view mirror 104 and the driver 106 may make further adjustments and/or fine-tune the positioning of the mirrors manually.

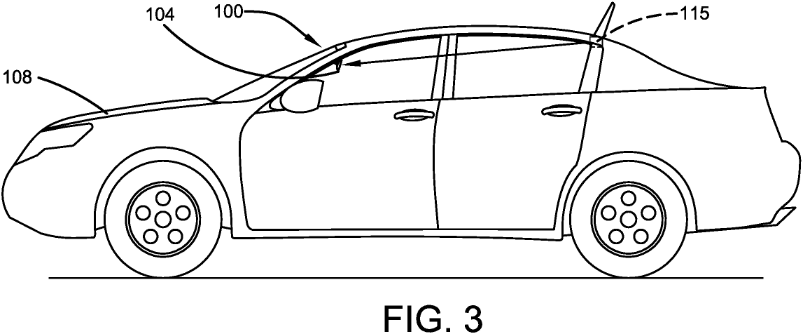

As shown in FIG. 3, the retinal-controlled mirror device 100 may be installed in the vehicle 108 at the time of manufacturing. For example, the retinal-controlled mirror device 100 may be installed on a particular type (i.e., model, make, year, etc.) of a newly manufactured vehicle 108.

In other embodiments, the retinal-controlled mirror device 100 may be installed in the vehicle 108 as a separate component (i.e., an after-market part). In one example, the retinal-controlled mirror device 100 may be designed and/or sold for a particular make/model of existing vehicle 108.

In yet another embodiment, the retinal-controlled mirror device 100 comprises a plurality of indicia 300. The vehicle mirrors 104 may include advertising, trademark, other letters, designs, or characters, printed, painted, stamped, or integrated into the mirror 104, or any other indicia 300 as is known in the art. Specifically, any suitable indicia 300 as is known in the art can be included, such as, but not limited to, patterns, logos, emblems, images, symbols, designs, letters, words, characters, animals, advertisements, brands, etc., that may or may not be vehicle, safety, or brand related.

Furthermore, the functions performed by the retinal-controlled mirror device 100 may be implemented using one or more of a conventional general purpose processor, digital computer, microprocessor, microcontroller, RISC (reduced instruction set computer) processor, CISC (complex instruction set computer) processor, SIMD (single instruction multiple data) processor, signal processor, central processing unit (CPU), arithmetic logic unit (ALU) and/or similar computational machines. Additionally, appropriate software, firmware, coding, routines, instructions, opcodes, microcode, and/or program modules may readily be prepared for use with device 100, as needed.

The device 100 may also be implemented by the preparation of ASICs (application specific integrated circuits), Platform ASICs, FPGAs (field programmable gate arrays), PLDs (programmable logic devices), CPLDs (complex programmable logic devices), sea-of-gates, RFICs (radio frequency integrated circuits), ASSPs (application specific standard products), one or more monolithic integrated circuits, one or more chips, and/or multi-chip modules or by interconnecting an appropriate network of conventional component circuits, modifications of which will be readily apparent to those of skill in the art.

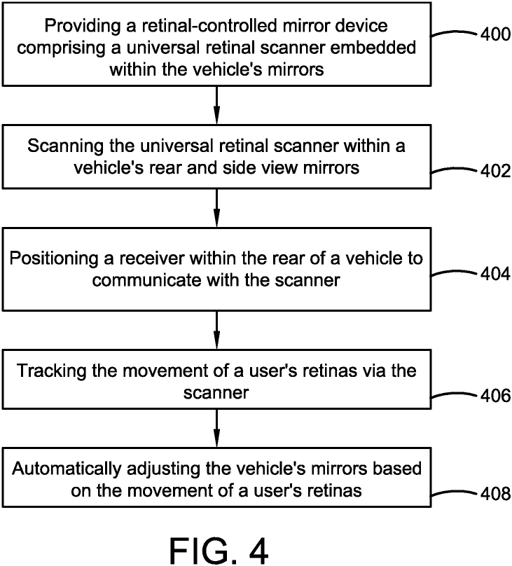

FIG. 4 illustrates a flowchart of the method of automatically adjusting a vehicle’s mirrors via a retinal scanner. The method includes the steps of at 400, providing a retinal-controlled mirror device comprising a universal retinal scanner embedded within the vehicle’s mirrors. The method also comprises at 402, securing the universal retinal scanner within a vehicle’s rear-view and side-view mirrors. Further, the method comprises at 404, positioning a receiver in the rear of a vehicle to communicate with the universal retinal scanner. The method also comprises at 406, tracking the movement of a user’s retinas via the universal retinal scanner. Finally, the method comprises at 408, automatically adjusting the vehicle mirrors based on the movement of a user’s retinas.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “retinal-controlled mirror device”, “mirror device”, and “device” are interchangeable and refer to the retinal-controlled device 100 of the present invention.

Notwithstanding the foregoing, the retinal-controlled mirror device 100 of the present invention can be of any suitable size and configuration as is known in the art without affecting the overall concept of the invention, provided that it accomplishes the above-stated objectives. One of ordinary skill in the art will appreciate that the retinal-controlled mirror device 100 as shown in FIGS. 1-4 are for illustrative purposes only, and that many other sizes and shapes of the retinal-controlled mirror device 100 are well within the scope of the present disclosure. Although the dimensions of the retinal-controlled mirror device 100 are important design parameters for user convenience, the retinal-controlled mirror device 100 may be of any size that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retinal-controlled mirror device that ensures a driver always has a clear line of sight through a vehicle’s mirrors, the retinal-controlled mirror device comprising:
a universal retinal scanner; and
a vehicle mirror;
wherein the universal retinal scanner is embedded within the vehicle mirror; and
further wherein the universal retinal scanner tracks movement of a user’s retinas and automatically adjusts the vehicle mirror to an optimal position based on a position of a user’s retinas.

2. The retinal-controlled mirror device of claim 1, wherein the universal retinal scanner allows multiple users of a vehicle to automatically adjust the vehicle mirror to a desired position.

3. The retinal-controlled mirror device of claim 2, wherein the universal retinal scanner communicates with a receiver positioned in a rear of the vehicle and is electrically connected to a motor to move the vehicle mirror.

4. The retinal-controlled mirror device of claim 3, wherein the universal retinal scanner includes an encasement substantially rectangular shaped with arcuate edges.

5. The retinal-controlled mirror device of claim 4, wherein a scanning lens is secured within the encasement for reading a retinal pattern of a user.

6. The retinal-controlled mirror device of claim 5, wherein a central processing unit is positioned within the encasement, and wherein the central processing unit is electrically connected to the scanning lens.

7. The retinal-controlled mirror device of claim 6, wherein an EEPROM chip is electrically connected to the central processing unit for storing retinal patterns of users.

8. The retinal-controlled mirror device of claim 7, wherein a shading member is secured around a peripheral edge of the encasement, surrounding the scanning lens for preventing contamination during scanning of a user’s retinas.

9. The retinal-controlled mirror device of claim 8, wherein the scanning lens, after identifying a user’s retinas, sends a signal to the central processing unit, which is configured to receive the signal and generate a signal to the motor to control movement of the vehicle mirror based on a user’s retina position.

10. The retinal-controlled mirror device of claim 1, wherein the universal retinal scanner is built into a top or a bottom of the vehicle mirror.

11. The retinal-controlled mirror device of claim 1, wherein the universal retinal scanner performs automatic adjustment of the vehicle mirror continuously, periodically or at fixed intervals.

12. The retinal-controlled mirror device of claim 1, wherein position of the vehicle mirror can be adjustable using manual controls, as well as the universal retinal scanner.

13. The retinal-controlled mirror device of claim 1, wherein the retinal-controlled mirror device may be installed in the vehicle at a time of manufacturing or as a separate, after-market component.

14. A retinal-controlled mirror device that ensures a driver always has a clear line of sight through a vehicle’s mirrors, the retinal-controlled mirror device comprising:
an universal retinal scanner with an encasement and a scanning lens secured within the encasement for reading a retinal pattern of a user; and
a vehicle mirror; and
wherein the universal retinal scanner is embedded within the vehicle mirror;
wherein the universal retinal scanner tracks movement of a user’s retinas and automatically adjusts the vehicle mirror to an optimal position based on a position of a user’s retinas;
wherein the universal retinal scanner communicates with a receiver positioned in a rear of the vehicle and is electrically connected to a motor to move the vehicle mirror;
wherein a central processing unit is positioned within the encasement, and wherein the central processing unit is electrically connected to the scanning lens;
wherein an EEPROM chip is electrically connected to the central processing unit for storing retinal patterns of users;
wherein a shading member is secured around a peripheral edge of the encasement, surrounding the scanning lens for preventing contamination during scanning of a user’s retinas; and
further wherein the scanning lens, after identifying a user’s retinas, sends a signal to the central processing unit, which is configured to receive the signal and generate a signal to the motor to control movement of the vehicle mirror based on a user’s retina position.

15. The retinal-controlled mirror device of claim 14 further comprising a plurality of indicia.

16. The retinal-controlled mirror device of claim 14, wherein the universal retinal scanner is built into a top or a bottom of the vehicle mirror.

17. The retinal-controlled mirror device of claim 14, wherein the universal retinal scanner performs automatic adjustment of the vehicle mirror continuously, periodically or at fixed intervals.

18. The retinal-controlled mirror device of claim 14, wherein position of the vehicle mirror can be adjustable using manual controls, as well as the universal retinal scanner.

19. The retinal-controlled mirror device of claim 14, wherein the retinal-controlled mirror device may be installed in the vehicle at a time of manufacturing or as a separate, after-market component.

20. A method of automatically adjusting a vehicle’s mirrors via a retinal scanner, the method comprising the following steps:
providing a retinal-controlled mirror device comprising a universal retinal scanner embedded within the vehicle’s mirrors;
securing the universal retinal scanner within a vehicle’s rear-view and side-view mirrors;
positioning a receiver in the rear of a vehicle to communicate with the universal retinal scanner;
tracking the movement of a user’s retinas via the universal retinal scanner; and
automatically adjusting the vehicle’s mirrors based on the movement of a user’s retinas.
